(19) United States
(12) Patent Application Publication
(10) Pub. No.: US 2004/0064485 A1
(43) Pub. Date: Apr. 1, 2004

(54) File management apparatus and method

(75) Inventors: Hideki Yoshida, Tokyo (JP); Toshibumi Seki, Tokyo (JP); Tatsunori Kanai, Tokyo (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/639,578

(22) Filed: Aug. 13, 2003

(30) Foreign Application Priority Data
Sep. 30, 2002 (JP) P2002-285539

(51) Int. Cl. G06F 12/00

(52) U.S. Cl. 707/201

(57) ABSTRACT

A first calculation unit calculates a first content hash based on a file to be written in response to a write request of the file. An encryption unit encrypts the file by using the first content hash, and generates an encrypted file. A second calculation unit calculates a second content hash based on the encrypted file. An encryption file memory correspondingly stores the encrypted file and the second content hash. A content hash pair memory correspondingly stores the first content hash and the second content hash.

### CROSS-REFERENCE TO RELATED APPLICATIONS

This application is based upon and claims the benefit of priority from the prior Japanese Patent Application P2002-85539, filed on Sep. 30, 2002; the entire contents of which are incorporated herein by reference.

### FIELD OF THE INVENTION

The present invention relates to a file management apparatus and a method for encrypting a file and storing an encrypted file by using a content hash.

### BACKGROUND OF THE INVENTION

In a file system of a computer, in the case of storing a file, a one way function is usually applied to a content of the file and the return value (it is called a content hash or a finger print) is used as a name of the file (a file name). In this method, the one way function is predetermined, and the return value uniquely corresponds to the content of the file. In other words, the same content of the file is not doubly (triply, and so on) stored by each of different file names. Accordingly, a space efficiency of a disk and a hit ratio of a cache memory raise, and a verification whether the read content is really the file content corresponding to the file name is possible. For example, it can be examined whether the file name (a content hash) coincides with a content hash calculated from the read content.

On the other hand, in the case of writing a file in the file system, the file is often encrypted by using a symmetric key encryption (a conventional encryption) in order for a third party not to read the content. One user (application program) encrypts the file content by using some encryption key and writes the encrypted content in the file system. Another user (application program) reads the encrypted content from the file system, decrypts the encrypted content by using the same encryption key, and obtains the original content as the decryption result. The same user may write and read the file content. Otherwise, one user may write the file content and another user may read the file content in the case that these users commonly own the same encryption key.

If object data is encrypted by using the encryption key in the file system, the following problem may occur. In a normal encryption method, the encryption key is generated by a random number irrelevant to content of the object data, and the content is encrypted by using the encryption key. Assume that two users independently wish to encrypt the same content by using the encryption key and store the encrypted content in the file system. In this case, each encryption key of two users is differently generated by a random number. As a result, each encrypted content of two users is different and a content hash is differently generated from each encrypted content. Accordingly, each encrypted content is differently stored by its content hash (different file name) in the file system. Briefly, each encrypted content is stored as a different file.

In order to solve this problem, it is considered that the same encryption key can be used at every time of encryption. However, in this method, if the same encryption key is leaked out by others, the encrypted contents of all files using the same encryption key can be decrypted. Accordingly, the use of encryption is limited.

Furthermore, in one prior art data management system, an encryption key is generated from a combination of CRC sign (a kind of content hash) and a specially prepared primary key. The object data is encrypted by using this encryption key. This method is disclosed in Japanese Patent Publication (Kokai) P2001-007802. However, in this method, if the same content of the object data is respectively encrypted by using each different primary key, each encrypted content is different. Accordingly, a merit that the object data is stored by a content hash as a file name is not acquired. Concretely, the merit that the same original content (unencrypted content) is respectively stored as the same file is not acquired because a different primary key is respectively used. In this method, a purpose of using the CRC is the persistent generation of a different encryption key at every time of encryption.

As mentioned-above, in the file system in which a file (data) is written by the content hash as the file name, if the same encryption key is commonly used for each content of all files, its damage is spread when the same encryption key is leaked out. On the other hand, if a different encryption key is respectively used for each content of all files, even if the same content is encrypted, each encrypted content is different and stored as each different file name in the file.

### SUMMARY OF THE INVENTION

The present invention is directing to a file management apparatus and a method for keeping a merit of the file system storing a file by the content hash without using a common encryption key or a temporary changeable encryption key for each file.

According to an aspect of the present invention, there is provided a file management apparatus, comprising: a first calculation unit configured to calculate a first content hash based on a file to be written in response to a write request of the file; an encryption unit configured to encrypt the file by using the first content hash, and to generate an encrypted file; a second calculation unit configured to calculate a second content hash based on the encrypted file which is encrypted by said encryption unit; an encryption file memory configured to correspondingly store the encrypted file and the second content hash; and a content hash pair memory configured to correspondingly store the first content hash and the second content hash.

According to other aspect of the present invention, there is also provided a method for managing a file, comprising: calculating a first content hash based on the file to be written in response to a write request of the file; encrypting the file by using the first content hash; calculating a second content hash based on an encrypted file; correspondingly storing the encrypted file and the second content hash in an encryption file memory; and correspondingly storing the first content hash and the second content hash in a content hash pair memory.

According to still other aspect of the present invention, there is also provided a computer program product, comprising: a computer readable program code embodied in said product for causing a computer to manage a file, said computer readable program code comprising: a first program code to calculate a first content hash based on the file to be written in response to a write request of the file; a second program code to encrypt the file by using the first content hash; a third program code to calculate a second content hash based on an encrypted file; a fourth program code to correspondingly store the encrypted file and the second content hash in an encryption file memory; and a fifth program code to correspondingly store the first content hash and the second content hash in a content hash pair memory.

### BRIEF DESCRIPTION OF THE DRAWINGS

FIG. 1 is a block diagram of a file management system according to one embodiment of the present invention.

FIG. 2 is a schematic diagram of a data structure of an encryption file memory unit in the file management system of FIG. 1.

FIG. 3 is a schematic diagram of a data structure of a content hash pair memory unit in the file management system of FIG. 1.

FIG. 4 is a block diagram of a file write unit in the file management system of FIG. 1.

FIG. 5 is a flow chart of processing of the file write unit according to one embodiment of the present invention.

FIG. 6 is a block diagram of a file read unit in the file management system of FIG. 1.

FIG. 7 is a flow chart of processing of the file read unit according to one embodiment of the present invention.

FIG. 8 is a block diagram of a file management system according to another embodiment of the present invention.

FIG. 9 is a flow chart of processing from a read request to a file write of the file management system according to another embodiment of the present invention.

FIG. 10 is a flow chart of processing from a file read to a read response of the file management system according to another embodiment of the present invention.

### DETAILED DESCRIPTION OF THE EMBODIMENTS

Hereinafter, various embodiments of the present invention will be explained by referring to the drawings.

In a file management system (a file system) of the present invention, a file content received from an application program is encrypted and written in a memory. Furthermore, the encrypted file content is read from the memory, decrypted and returned to the application program.

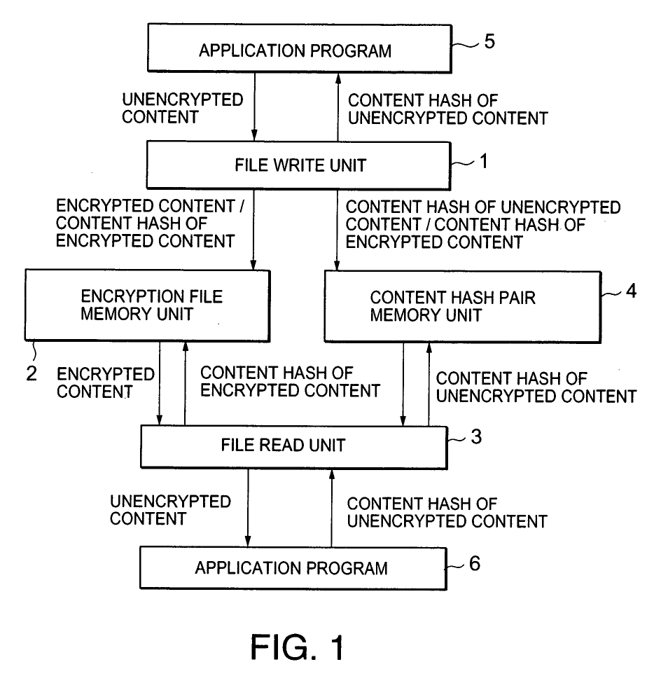

FIG. 1 is a block diagram of the file management system according to one embodiment of the present invention. As shown in FIG. 1, the file management system includes a file write unit 1, an encryption file memory unit 2, a file read unit 3 and a content hash pair memory unit 4.

As used herein, those skilled in the art will understand that the term “unit” is broadly defined as a processing device (such as a server, a computer, a microprocessor, a microcontroller, a specifically programmed logic circuit, an application specific integrated circuit, a discrete circuit, etc.) that provides the described communication and functionality desired. While such a hardware-based implementation is clearly described and contemplated, those skilled in the art will quickly recognize that a “unit” may alternatively be implemented as a software module that works in combination with such a processing device.

Depending on the implement constraints, such a software module or processing device may be used to implement more than one “unit” as disclosed and described herein. Those skilled in the art will be familiar with particular and conventional hardware suitable for use when implementing an embodiment of the present invention with a computer or other processing device. Likewise, those skilled in the art will be familiar with the availability of different kinds of software and programming approaches suitable for implementing one or more “units” as one or more software modules.

For example, the file write unit 1 and the file read unit 3 may be implemented as a form such as an operating system, a server program and a library. A computer operating a file system and a computer operating an application program may be implemented as the same computer or each different computer. Furthermore, the file write unit 1, the encryption file memory unit 2, the file read unit 3 and the content hash pair memory unit 4 may be distributed among a plurality of computers. It is desired that the encryption file memory unit 2 (more generally implemented and called the encryption file memory) and the content hash pair memory unit 4 (more generally implemented and called the content hash memory) are mutually located on two different apparatuses. In this case, even if one of the computer including the encryption file memory unit 2 and the computer including the content hash pair memory unit 4 is invaded and data is maliciously read out, the content of the original file cannot be read. Furthermore, each memory unit 2 and 4 may be located on an apparatus except for the computer. For example, the content hash pair memory unit 4 may be stored in a portable memory device, such as a card type or a stick type, in order for a user to maintain. An application program 5 for writing and an application program 6 for reading may be the same program or different programs. Furthermore, a computer operating the application program 5 and a computer operating the application program 6 may be the same computer or different computers.

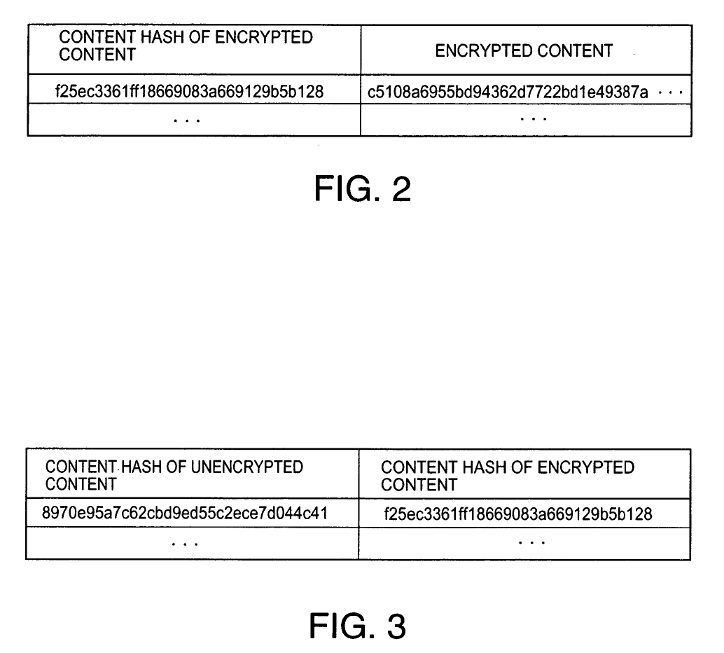

FIG. 2 shows an example of the data structure of the encryption file memory unit 2 in the file system of FIG. 1. In the encryption file memory unit 2, a “content hash of encrypted content” and an “encrypted content” are correspondingly stored. FIG. 3 shows an example of data structure of the content hash pair memory unit 4 in the file system of FIG. 1. In the content hash memory unit 4, a “content hash of unencrypted content” and the “content hash of encrypted content” are correspondingly stored for the same content as original data. A content hash is a short numerical value determined from a content of a file by a predetermined calculation method. This numerical value may be varying. However, from a view point of easiness of processing, a fixed-length numerical value may be better.

As a method for calculating the content hash, a hash function such as MD-5 and SHA-1 can be used. The hash functions are used as an electronic signature for data. As for arbitrary data given, this data is converted to the numerical value of 128 bits in the case of “MD-5”. Alternatively, this data is converted to the numerical value of 160 bits in the case of “SHA-1”. A kind of the hash function is uniquely determined as a method for calculating the content hash of unencrypted content and a method for calculating the content hash of encrypted content.

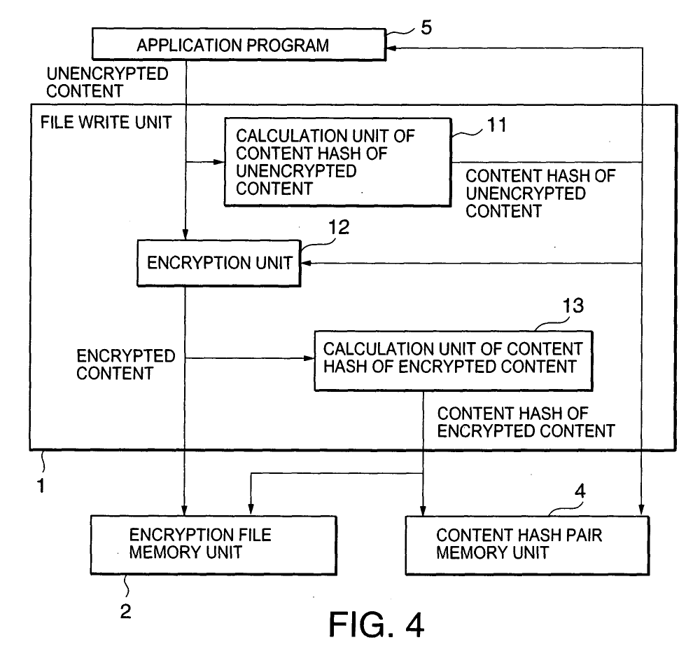

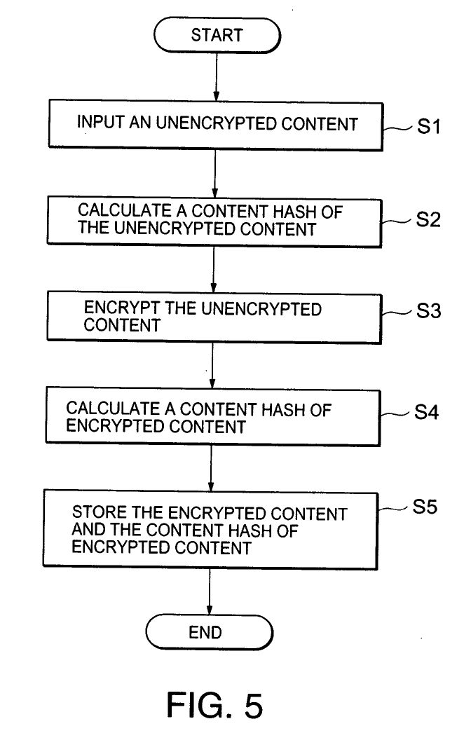

FIG. 4 is a block diagram of the file write unit 1 in the file system of FIG. 1. FIG. 5 is a flow chart of processing of the file write unit 1. Hereafter, write processing of the file of the present invention is explained by referring to FIGS. 4 and 5. When the file write unit 1 receives. an unencrypted content (original content before encryption) of an object file from the application program 5 (S1), a calculation unit 11 of content hash of unencrypted content (a first calculation unit 11) calculates a content hash from the unencrypted content (S2). An encryption unit 12 encrypts the unencrypted content by using the content hash of the unencrypted content as the encryption key (S3). Briefly, the encryption unit 12 generates an encrypted content as the encryption result. A calculation unit 13 of content hash of encrypted content (a second calculation unit 13) calculates a content hash from the encrypted content (S4). A pair of the content hash of unencrypted content and the content hash of encrypted content is stored in the content hash pair memory unit 4. Furthermore, the encrypted content and the content hash of encrypted content are stored in the encryption file memory unit 2 (S5).

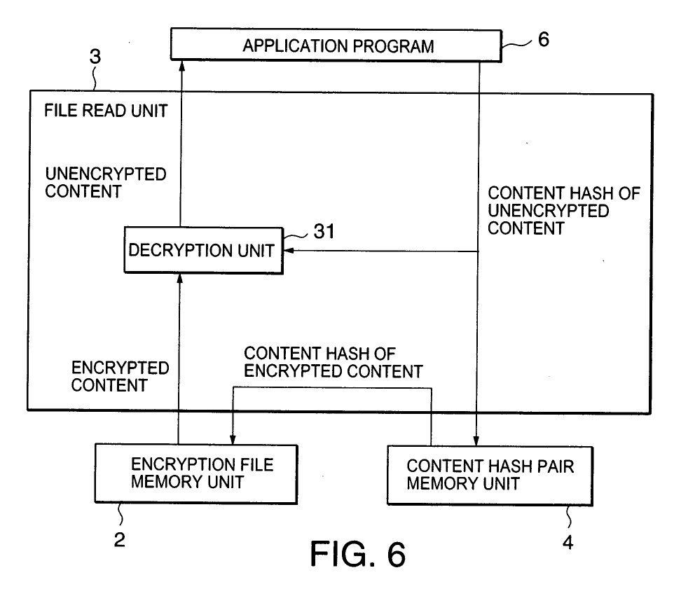

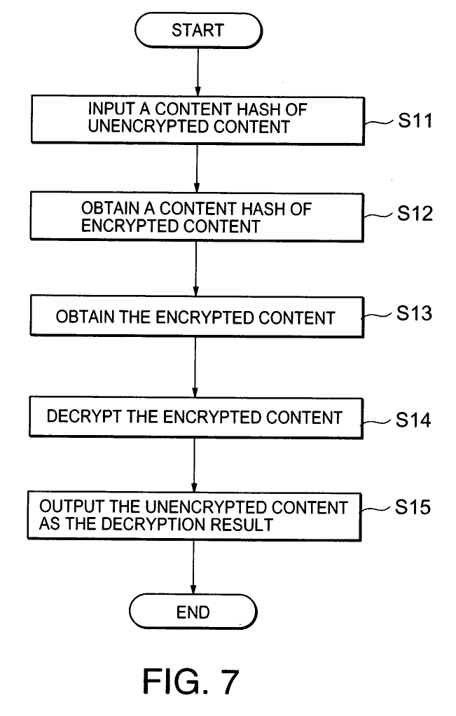

Next, FIG. 6 is a block diagram of the file read unit 3 in the file system of FIG. 1. FIG. 7 is a flow chart of processing of the file read unit 3. Hereafter, read processing of a file of the present invention is explained by referring to FIGS. 6 and 7. When the file read unit 3 receives the content hash of unencrypted content of the object file from the application program 6 (S11), the content hash of unencrypted content is supplied to the content hash pair memory unit 4. The content hash of encrypted content corresponding to the content hash of unencrypted content is read from the content hash pair memory unit 4 and returned to the file read unit 3 (S12). The content hash of encrypted content is supplied to the encrypted file memory unit 2. The encrypted content corresponding to the content hash of encrypted content is read from the encryption file memory unit 2 and returned to the file read unit 3 (S13). A decryption unit 31 decrypts the encrypted content by using the content hash of unencrypted content as the encryption key (S14). Briefly, the decryption unit 31 generates the unencrypted content (original content) as the decryption result. Last, this unencrypted content is output to the application program 6 (S15).

In the present embodiment, when a plurality of users respectively try to encrypt the same content, the same content hash (encryption key) is respectively generated from the same content of each user and the same content of each user is respectively encrypted by using the same encryption key. Briefly, the encrypted content of each user is the same. As a result, the same content hash (file name) is respectively generated from the same encrypted content and each encrypted content is stored by the same file name in the file system. Accordingly, the same encrypted content is stored as the same file name and a disk area can be effectively used. Furthermore, in the case of caching the file by the file name, a ratio to hit the cache memory raises, and a time and a communication cost to read/write the file are deleted.

Next, the above-mentioned file system is applied to a client server system such as a web server. Concretely, a dual proxy server system in which a proxy server is located on the client side and another on the server side is utilized. Hereafter, this application example is explained.

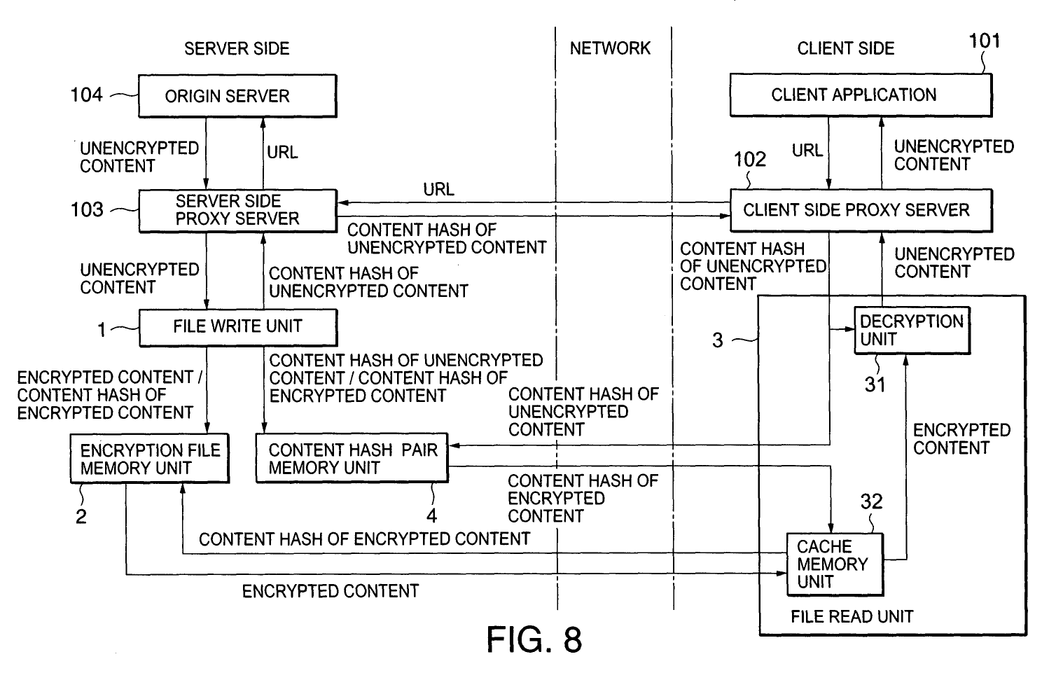

FIG. 8 is a block diagram of the example server system applied to the dual proxy server system according to another embodiment of the present invention. In FIG. 8, an original server 104, a server side proxy server 103, the file write unit 1, the encryption file memory unit 2 and the content hash pair memory unit 4 are located on a server side network. Furthermore, a client application 101, a client side proxy server 102 and the file read unit 3 are located on a client side network. In the file read unit 3, in addition to internal component of the file read unit 3 of FIG. 6, a cache memory unit 32 (more generally implemented and called the cache memory) to correspondingly store the content hash of the encrypted content and the encrypted content is included. The server side network and the client side network can mutually communicate through a network such as the Internet. In the server side network, the origin server 104, the server side proxy server 103, the file write unit 1, the encryption file memory unit 2 and the content hash pair memory unit 4 may be located on the same computer or distributed among a plurality of computers. Furthermore, in the client side network, the client application 101, the client side proxy server 102 and the file read unit 3 may be located on the same computer or distributed among a plurality of computers.

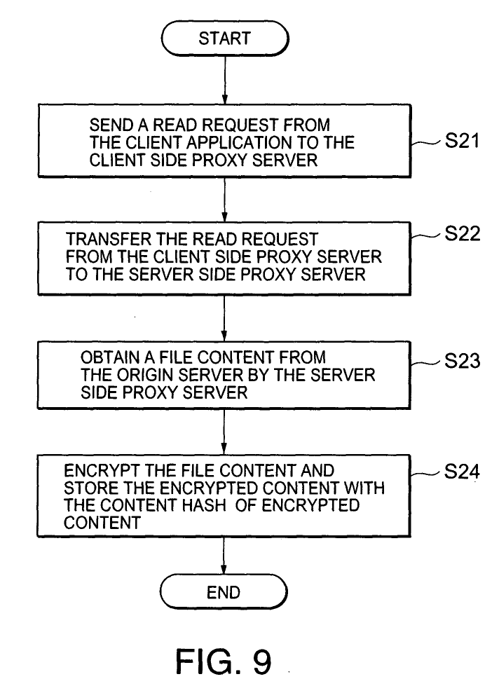

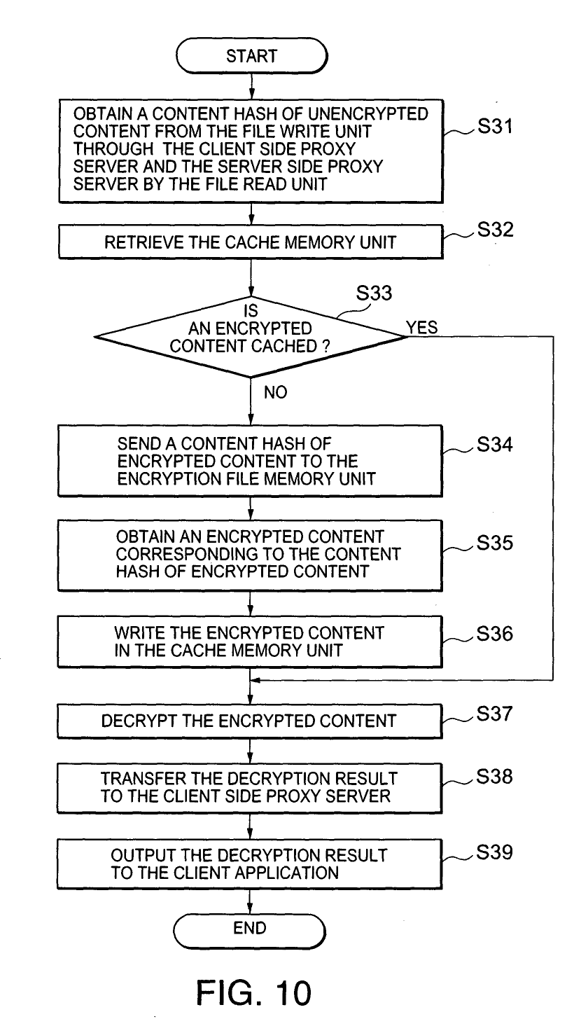

FIG. 9 is a flow chart of processing from “a read request” to “file write” in the file system of FIG. 8 according to another embodiment of the present invention. FIG. 10 is a flow chart of processing from “file read” to “read response” in the file system of FIG. 8 according to yet another embodiment of the present invention. Hereafter, processing of “file write/read” in the file system of FIG. 8 is explained by referring to FIGS. 9 and 10. When the client side proxy server 102 receives a data read request with URL from the client application 101 (S21), the client side proxy server 102 transfers the data read request with URL to the server side proxy server 103 (S22). The server side proxy server 103 connects to the origin server 104 based on the URL, and obtains a file content corresponding to the URL from the origin server 104 (S23). The file content is supplied to the file write unit 1. In the same way as the above-mentioned processing, the file content is encrypted, the encrypted content and the content hash of encrypted content are stored in the encryption file memory unit 2, and the content hash of unencrypted content and the content hash of encrypted content are stored in the content hash pair memory unit 4 (S24). On the other hand, the content hash of unencrypted content is sent to the client side proxy server 102 (S31). The client side proxy server 102 supplies the content hash of unencrypted content to the file read unit 3 (S31). The file read unit 3 reads the content hash of encrypted content corresponding to the content hash of unencrypted content from the content hash pair memory 4 in the server side network, and reads the encrypted content corresponding to the content hash of encrypted content from the encryption file memory unit 2 on the server side network. The decryption unit 31 in the file read unit 3 decrypts the encrypted content by using the content hash of unencrypted content as a decryption key (S37). However, the file read unit 3 includes the cache memory unit 32. Accordingly, before sending a read request of the encrypted content to the encryption file memory unit 2, the cache memory unit 32 is retrieved by the content hash of encrypted content (S32). If an encrypted content corresponding to the content hash of encrypted content is found in the cache memory unit 32 (S33), the encrypted content is retrieved from the cache memory 32 and supplied to the decryption unit 31 (S37). On the other hand, if the encrypted content is not found in the cache memory unit 32 (S33), the content hash of encrypted content is supplied to the encryption file memory unit 2 (S34), corresponding encrypted content is received (S35) and written in the cache memory unit 32 (S36). This encrypted content is decrypted by the decryption unit 31 (S37). After a decryption result (the unencrypted content) is obtained, the decryption result is supplied to the client side proxy server (S38) and further output to the client application 101 (S39).

In this application example, on the client side network, the encrypted content and the content hash of encrypted content are only stored. On the other hand, the content hash of unencrypted content usable as the decryption key is only stored on the server side network. Accordingly, even if others furtively look on the client side network or on the server side network, the others cannot read a content of an original file. In general, the computer on the server side network is more strictly managed in comparison with the computer on the client side network. Accordingly, this system is effective to prevent hacking or unauthorized access and reading.

In order to further effectuate this system, when the server side proxy server 103 receives the URL from the client side proxy server 102 and returns the content hash of unencrypted content to the client side proxy server 102, the content hash of encrypted content with the content hash of unencrypted content may be returned. In this method, communication between the server side network and the client side network can be reduced as one time.

As mentioned-above, in an embodiment of the present invention, a merit of the file system storing data by the content hash as a file name can be kept without using a common encryption key and a temporary changeable encryption key for each file.

For alternative embodiments of the present invention, the processing of the present invention can be accomplished by a computer-executable program, and this program can be realized in a computer-readable memory device.

In such embodiments of the present invention, the memory device, such as a magnetic disk, a floppy disk, a hard disk, an optical disk (CD-ROM, CD-R, DVD, and so on), an optical magnetic disk (MD, and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In such embodiments of the present invention, the computer executes each processing stage of the embodiments according to the program stored in the memory device. The computer may be one apparatus such as a personal computer or a system in which a plurality of processing apparatuses are connected through the network. Furthermore, in the present invention, the computer is not limited to the personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A file management apparatus, comprising:
a first calculation unit configured to calculate a first content hash based on a file to be written in response to a write request of the file;
an encryption unit configured to encrypt the file by using the first content hash;
a second calculation unit configured to calculate a second content hash based on an encrypted file which is encrypted by said encryption unit;
an encryption file memory configured to correspondingly store the encrypted file and the second content hash; and
a content hash pair memory configured to correspondingly store the first content hash and the second content hash.

2. The file management apparatus according to claim 1, further comprising:
a first read unit configured to read the second content hash corresponding to the first content hash from said content hash pair memory in response to a read request of the file by indicating the first content hash;
a second read unit configured to read the encrypted file corresponding to the second content hash from said encryption file memory;
a decryption unit configured to decrypt the encrypted file as a decryption result by using the first content hash as a decryption key; and
a supply unit configured to supply the file to a request source of the read request.

3. The file management apparatus according to claim 1,
wherein said supply unit supplies the first content hash to a request source of the write request.

4. The file management apparatus according to claim 3,
wherein the request source of the write request is a first application program and the request source of the read request is a second application program.

5. The file management apparatus according to claim 3,
wherein the request source of the write request is the same as the request source of the read request.

6. The file management apparatus according to claim 2,
wherein said first calculation unit calculates the first content hash by a first hash function,
wherein said second calculation unit calculates the second content hash by a second hash function, and
wherein the first hash function and the second hash function respectively represent a predetermined calculation method.

7. The file management apparatus according to claim 1,
wherein the encryption unit, the first calculation unit and the second calculation unit are distributed among a plurality of computers; and
wherein at least one of said encryption file memory and said content hash pair memory is located on one of the plurality of computers which most protects an invasion from outside.

8. The file management apparatus according to claim 1,
wherein at least one of said encryption file memory and said content hash pair memory is a portable memory device.

9. The file management apparatus according to claim 2,
if each of the first calculation unit, the encryption unit, the second calculation unit, the encryption file memory, the content hash memory, the first read unit, the second read unit, the decryption unit and the supply unit is distributed between a server side network and a client side network,
wherein said first calculation unit, said encryption unit, said second calculation unit, said encryption file memory and said content hash pair memory, are located on the server side network, and
wherein said first read unit, said second read unit, said decryption unit and said supply unit, are located on the client side network.

10. The file management apparatus according to claim 9,
wherein the request source of the read request is a client application program existing on the client side network.

11. The file management apparatus according to claim 10,
when the client application program generates a read request of the file with a URL associated with the file,
wherein a client side proxy server of the client side network sends the URL to a server side proxy server of the server side network, and receives the first content hash of the file associated with the URL from the server side proxy server of the server side network.

12. The file management apparatus according to claim 11,
wherein said first read unit of the client side network sends the first content hash to said content hash pair memory of the server side network, and receives the second content hash corresponding to the first content hash from said content hash pair memory of the server side network.

13. The file management apparatus according to claim 12,
wherein said second read unit of the client side network sends the second content hash to said encryption file memory of the server side network, and receives the encrypted file corresponding to the second content hash from said encryption file memory of the server side network.

14. The file management apparatus according to claim 13,
further comprising a cache memory configured to correspondingly store the encrypted file and the second content hash on the client side network, and
wherein said second read unit first retrieves the encrypted file corresponding to the second content hash from said cache memory unit.

15. The file management apparatus according to claim 14,
if said second read unit cannot retrieve the encrypted file corresponding to the second content hash from said cache memory unit,
wherein said second read unit sends the second content hash to said encryption file memory unit of the server side network.

16. The file management apparatus according to claim 15,
wherein said decryption unit of the client side network decrypts the encrypted file by using the first content hash, and
wherein said supply unit of the client side network outputs the file to the client application program.

17. A method for managing a file, comprising:
receiving a write request of the file;
calculating a first content hash based on the file in response to the write request of the file;
encrypting the file by using the first content hash;
calculating a second content hash based on an encrypted file;
correspondingly storing the encrypted file and the second content hash in an encryption file memory; and
correspondingly storing the first content hash and the second content hash in a content hash pair memory.

18. The method according to claim 17, further comprising:
receiving a read request of the file;
reading the second content hash corresponding to the first content hash from the content hash pair memory in response to the read request of the file by indicating the first content hash;
reading the encrypted file corresponding to the second content hash from the encryption file memory;
decrypting the encrypted file as a decryption result by using the first content hash as a decryption key; and
supplying the file to a request source of the read request.

19. A computer program product, comprising:
a computer readable program code embodied in said product for causing a computer to manage a file, said computer readable program code comprising:
a first program code to calculate a first content hash based on the file to be written in response to a write request of the file;
a second program code to encrypt the file by using the first content hash;
a third program code to calculate a second content hash based on an encrypted file;
a fourth program code to correspondingly store the encrypted file and the second content hash in an encryption file memory; and
a fifth program code to correspondingly store the first content hash and the second content hash in a content hash pair memory.

20. The computer program product according to claim 19, further comprising:
a sixth program code to read the second content hash corresponding to the first content hash from the content hash pair memory in response to a read request of the file by indicating the first content hash;
an seventh program code to read the encrypted data corresponding to the second content hash from the encryption file memory;
a eighth program code to decrypt the encrypted file as a decryption result by using the first content hash as a decryption key; and
a ninth program code to supply the file to a request source of the read request.
